(19) United States
(12) Patent Application Publication
(10) Pub. No.: US 2003/0233573 A1
(43) Pub. Date: Dec. 18, 2003

(54) System and method for securing network communications

(76) Inventor: Thomas L. Phinney, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/463,560

(22) Filed: Jun. 17, 2003

Related U.S. Application Data
(60) Provisional application No. 60/390,683, filed on Jun. 18, 2002.

(51) Int. Cl. H04L 9/00

(52) U.S. Cl. 713/200

(57) ABSTRACT

A system and method of user installable devices that self-establish and maintain their own unique communications security system to provide secure communications in a control system, such as a supervisory control and data acquisition (SCADA) system with a wide area network (WAN) is disclosed. This security system provides source authentication, confidentiality, integrity protection, and replay protection.

### CROSS REFERENCE

This application claims priority of U.S. Provisional Patent Application Serial No. 60/390,683, filed on Jun. 18, 2002, entitled “METHOD FOR SCADA COMSEC,” which is incorporated herein by reference.

This application is further related to co-pending and co-owned patent applications entitled: “MASTER DONGLE FOR A SECURED DATA COMMUNICATIONS NETWORK,” Honeywell Docket No. I20-04611, U.S. Ser. No. 10/___,___; “DONGLE FOR A SECURED DATA COMMUNICATIONS NETWORK,” Honeywell Docket No. I20-04612, U.S. Ser. No. 10/___,___; “METHOD FOR CONFIGURING AND COMMISSIONING CSMs,” Honeywell Docket No. I20-04613, U.S. Ser. No. 10/___,___; “METHOD FOR CONFIGURING AND COMMISSIONING CSSs,” Honeywell Docket I20-04614, U.S. Ser. No. 10/___,___; “METHOD FOR ESTABLISHING SECURE NETWORK COMMUNICATIONS,” Honeywell Docket No. I20-04615, U.S. Ser. No. 10/___,___, all filed on Jun. 17, 2003, and all having a common assignee as the present invention.

### BACKGROUND

1. Field of the Invention

The present invention generally relates to communications security and relates in particular to source authentication, confidentiality, integrity protection, and replay protection in a control system.

2. Description of the Related Art

In an age of growing computer literacy and organized social disorder, there is an increasing need to protect corporate resources and national critical infrastructure from cyberattacks. For example, the electric power industry needs protection for the information carried on communication links between centralized control centers and outlying equipment sites.

Without such protection, an eavesdropping competitor, through modeling (for instance, with a neural network), can evaluate the rough economics of a system's operation and then use that knowledge of incremental cost to provide a bidding edge in the real-time marketplace. If eavesdropping is ongoing, this information advantage is magnified.

Without information protection, those of ill intent can determine the state of a system to select the most opportune moment and method of attack. More active assailants can take control of the communications and through it take control of the outlying sites. Through misrepresentation of the state of those outlying sites, they may also induce actions by the central control system and its operators that degrade or damage other parts of the system's operation or even its physical integrity.

There is an urgent need for cyber protection of such communication links, including:

1. Protecting communicated information from disclosure to unauthorized eavesdroppers;

2. Detecting and rejecting messages that originated from an unauthorized source or were altered in transit by an unauthorized source; and

3. Detecting and rejecting unaltered messages that originated from an authorized source when they were recorded but then replayed at a later time.

Any system that protects electronic communications against unauthorized message senders needs to fail-safe so that unauthorized messaging is still rejected after potential failure conditions. Otherwise, an organized attacking group can take over field sites simply by intercepting the transmission paths, such as a telephone switching site or microwave relay, and substituting its own messages.

The ability to initiate such an attack can be put in place and go undetected for months or years before any use. Telephone switches can and have been hacked. Trojaned equipment can be substituted for the original. In this modern era of multinational terrorists and state-funded cyberwarriors, such modes of attack cannot be discounted.

Once a threat is appreciated, however vaguely, protective measures can be planned and risks mitigated. New systems can be designed to reduce the threat. Cyberprotection for communications can be included in new designs from the start, provided the industry can agree on an adequate common approach for its multiple vendors to follow. Existing systems pose a different problem. In general, they cannot be redesigned and so must instead be retrofitted to protect against the threat. Therein lies the most difficult problem.

Even within a single company, the communication links that need to be protected typically use a heterogeneous collection of incompatible protocols implemented in multiple generations of equipment from a variety of vendors. The problem is further complicated with intertie of originally disjoint systems resulting from corporate mergers, asset transfers, and restructuring, as well as that resulting from centralizing control and maintenance for improved productivity.

Most of the existing communications equipment is itself too old to modify. In many cases, the designers are dead or long retired and sometimes the vendor companies themselves no longer exist. Standard industry practice is to use the existing equipment as long as possible, because there is little or no economic justification for replacing the old equipment. Any approach to providing cybersecurity for such equipment needs to address these constraints.

When additional equipment is inserted inline on a communications path, it imposes both physical and performance burdens on the system. The physical burdens are those of housing, powering, connecting, and maintaining the new equipment. The performance burdens are those caused by the delay in communications induced by the new equipment and by the unavoidable increase in the failure rate of the communications path.

The physical burden imposed by new equipment is a major concern. If it takes a crane or forklift operator to deliver an industrially-hardened enclosure, facilities personnel to install it, a communications technician to install the new equipment in the enclosure and to wire it into the existing communications system, and a licensed electrician to provide the equipment's power, the economic burden of adding cyberprotection is great.

Millions of systems in corporate resources and national infrastructure are vulnerable and unsecured. There is a critical need for a security system that can be flexibly implemented without disrupting an existing system.

### SUMMARY OF THE INVENTION

A system secures network communications and comprises a first security component, a second security component, and a security management component. The first security component, the second security component, and the security management component are capable of providing security for a communication between the first task-oriented component and the second task-oriented component. The security includes source authentication, confidentiality, integrity protection, and replay protection. The first task-oriented component is in communication with the first security component. The first security component is in communication with the communications component. The communications component is in communication with the second security component. The second security component is in communication with the second task-oriented component. The security management component is in communication with the first security component.

In some embodiments, the first security component is a dongle. In others, the first security component comprises executable instructions capable of being stored in the first task-oriented component. Likewise, the second security component either is a dongle or comprises executable instructions capable of being stored in the second task-oriented component.

In some embodiments, the first task-oriented component is a first master terminal unit (MTU) and the second task-oriented component is a first remote terminal unit (RTU) in a control system, such as a supervisory control and data acquisition (SCADA) system. In non-SCADA control systems, MTUs and RTUs are frequently peers. The system sometimes has a third security component in communication with the communications component. The third security component is in communication with a second remote terminal unit (RTU). The first security component, the third security component, and the security management component are capable of providing source authentication, confidentiality, integrity protection, and replay protection for a communication between the first master terminal unit (MTU) and the second remote terminal unit (RTU). The system sometimes has a second master terminal unit (MTU) and a third security component in communication with the second master terminal unit (MTU). The first security component, the third security component, and the security management component are capable of providing source authentication, confidentiality, integrity protection, and replay protection for a communication between the second master terminal unit (MTU) and the first remote terminal unit (RTU). The control system is applicable to many systems, such as power transmission and distribution systems, oil and gas pipeline systems, and water and sewage management systems.

In some embodiments, the first master terminal unit (MTU) is part of a control site. The communications component is sometimes a wide area network (WAN). The security management component serves executable instructions to the first security component. The security management component also serves keys to the first security component and has access to a random number source. The second task-oriented component is sometimes a field instrument. The second task-oriented component is located remotely from the first task-oriented component.

Another embodiment is a method for securing network communications. A first security component is precommissioned with a unique identifier and at least one cryptographic secret. The first security component is deployed to be in communication with a first task-oriented component and a communications component. A security management component commissions the first security component, during an encrypted dialog with the first task-oriented component and a second task-oriented component. A second security component is deployed to be in communication with the communications component. The second security component is commissioned. The first security component and the second security component alter a communication between the first task-oriented component and the second task-oriented component. The first security component, the second security component, and the security management component are capable of providing security for a communication between the first task-oriented component and the second task-oriented component. The security includes source authentication, confidentiality, integrity protection, and replay protection.

In precommissioning, a boot loader and a session key are downloaded to the first security component. Executable instructions enciphered under the session key are downloaded to the first security component. A class identifier and a serial number are downloaded to the first security component. A birth key encryption key (KEK) is downloaded to the first security component. At least one version of said birth key encryption key (KEK) is downloaded to the first security component. The first security component is sometimes a dongle that has an indicator to indicate that precommissioning has been completed.

Sometimes, the first security component is interrogated to determine if it needs commissioning. In commissioning, a bootstrap program is activated on the first security component to erase a flash memory of the first security component. Executable instructions are provided to the first security component to load into the flash memory. The first security component is authenticated and validated.

In some embodiments, the unique identifier, the at least one cryptographic secrets, and the key information are stored.

As discussed above, the first security component and the second security component alter the communication between the first task-oriented component and the second task-oriented component. In altering, control and integrity information is added to a communication between the first task-oriented component and the second task-oriented component. The first security component adds this information and the second security component removes it.

In some embodiments, the first task-oriented component is a master terminal unit (MTU) and the second task-oriented component is a remote terminal unit (RTU) in a control system. The communications component is sometimes a wide area network (WAN).

In some embodiments, the first security component is a dongle interposed between the first task-oriented component and a modem.

These and other features, aspects, and advantages of the present invention will become better understood with reference to the following drawings, description, and appended claims.

### BRIEF DESCRIPTION OF THE DRAWINGS

FIG. 1 is a block diagram of one embodiment of a system for securing network communications according to the present invention.

FIG. 2 is a block diagram of another embodiment of a system for securing network communications according to the present invention.

FIG. 3 is a block diagram of a preferred embodiment of a system for securing network communications according to the present invention.

FIG. 4 is a block diagram of another example of a system for securing network communications according to the present invention.

FIG. 5 is a layout of a typical SCADA message structure and transformation for MTU to RTU messages and for RTU to MTU messages that are not necessarily reply messages.

FIG. 6 is a layout of a typical SCADA message structure and transformation for RTU to MTU reply messages when all RTU to MTU messages are necessarily reply messages.

FIGS. 7A, 7B, 7C, and 7D are layouts of message structures of various types of messaging protocols frequently used in SCADA and non-SCADA control systems.

### DETAILED DESCRIPTION OF THE PREFERRED EMBODIMENTS

In the following detailed description, reference is made to the accompanying drawings. These drawings form a part of this specification and show, by way of example, specific preferred embodiments in which the present invention may be practiced. These embodiments are described in sufficient detail to enable those skilled in the art to practice the present invention. Other embodiments may be used. Structural, logical, and electrical changes may be made without departing from the spirit and scope of the present invention. Therefore, the following detailed description is not to be taken in a limiting sense and the scope of the present invention is defined only by the appended claims.

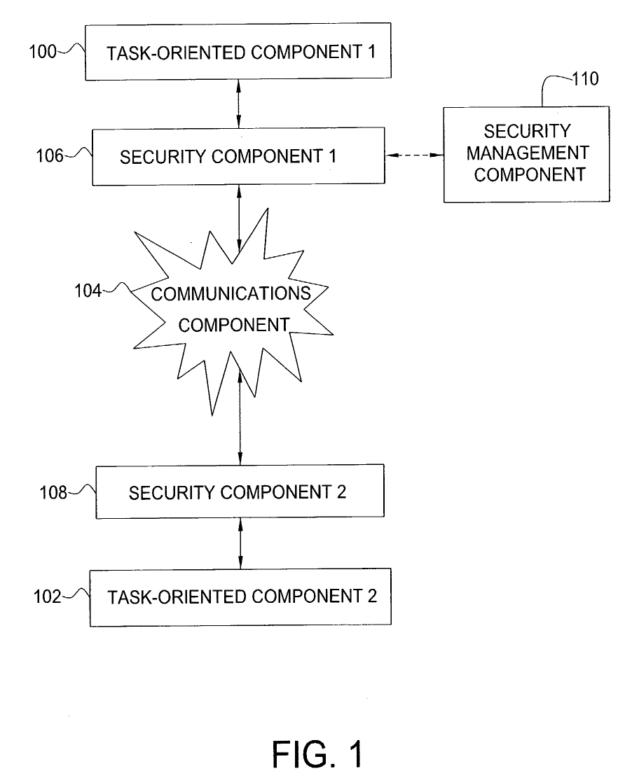

FIG. 1 shows one embodiment of a system for securing network communications. Security is defined as measures taken to protect a system. Also, security is a condition that results from the establishment and maintenance of protective measures that ensure a state of inviolability from hostile acts or influences. In practical terms, security hinges on good encryption, but good encryption is by far not enough to obtain good security; and a poorly-engineered system does not obtain sufficient security even though high-quality encryption might be employed. In addition, security is the condition of system resources being free from unauthorized access and from unauthorized or accidental change, destruction, or loss. In summary, security is the condition of a system that results from the establishment and maintenance of measures to protect the system.

In FIG. 1, a first task-oriented component 100 and a second task-oriented component 102 have secure communications over a communications component 104, such as a network. The secure communications are enabled by a first security component 106 and a second security component 108 with the help of a security management component 110. First task-oriented component 100 and second task-oriented component 102 are any two pieces of equipment capable of communicating over a network, such as two computers. They are task-oriented in that they primarily perform some task unrelated to communications, such as process control or automation. Communications component 104 is any kind of symmetric or asymmetric communications system. Some examples are a local area network (LAN), a wide area network (WAN), and the like.

First security component 106 and second security component 108 may be implemented in either hardware, as a dongle, or in software and operate to alter a communication between first task-oriented component 100 and second task-oriented component 102 in order to secure the communication. A dongle is a device that is capable of being attached to a standard connector on a computer, a modem, or a similar piece of equipment. The dongle is sometimes a small, hard-shelled device. The dongle is typically interposed between the connector and any cable for other equipment that might normally be attached to that connector.

A communication from first task-oriented component 100 to second task-oriented component 102 is processed by first security component 106 to alter the communication in a certain way before it passes to communications component 104. Then, second security component 108 alters the communication from communications component 104 in such a way as to restore the communication back to its unaltered form. The communication is then passed to second task-oriented component 102. In this way, the alteration is transparent to the task-oriented components.

In some embodiments, first security component 106 is a communications security master (CSM) and second security component 108 is a communications security slave (CSS).

A ComSec master (CSM) is software and related hardware in a ComSec dongle master (CSM dongle), or equivalent software and related hardware in a control system, such as a supervisory control and data acquisition (SCADA) master computer or controller. SCADA is a type of loosely-coupled distributed monitoring and control system commonly associated with electric power transmission and distribution systems, oil and gas pipelines, water and sewage systems, and other systems. A CSM performs several functions. First, a CSM configures and commissions each ComSec dongle slave (CSS) before deployment. Second, a CSM provides source authentication, confidentiality, integrity protection, and replay protection to the communications sent to and received from the deployed RTUs. Third, a CSM provides key management services, including key generation and key escrow, for the communications system. Fourth, a CSM provides code management services, including providing initial CSS code for non-dongle CSSs and code updates for all CSSs and other CSMs in the system. Finally, a CSM provides remote management, logging, and alarming of significant security events, via a network interface.

Authentication, confidentiality, integrity protection, and replay protection are various kinds of security. Authentication is any security measure designed to establish the validity of a transmission, message, or originator; also a means of verifying an individual's eligibility to receive specific categories of information. Confidentiality is the nonoccurrence of the unauthorized disclosure of information. Data integrity is the condition that exists when data is unchanged from its source and has not been accidentally or maliciously modified, altered, or destroyed. Data integrity protection is the degree to which a system or component detects unauthorized access to, or modification of, computer programs or data. Replay protection is validating message sequencing and timeliness so that prior valid messages cannot be replayed without detection of their lack of timeliness. A nonce is a random or non-repeating value that is included in data exchanged by a protocol, usually for the purpose of guaranteeing liveness and, thus, detecting and protecting against replay attacks. Spoofing is pretending to be another, as in one agent masquerading as another. More technically, spoofing is interception, alteration, and retransmission of a signal or data in such a way as to mislead the recipient.

A ComSec slave (CSS) is software and related hardware in a ComSec dongle for a remote terminal unit (RTU) or equivalent embedded software and assigned hardware in an RTU. A CSS provides source authentication, confidentiality, integrity protection, and replay protection to the communications received from and sent to the master terminal units (MTUs). A master terminal unit (MTU) is a master station in a control system. A remote terminal unit (RTU) is a remote station in a control system. In some embodiments, the CSM performs some or all of the functions of security management component 110.

Deploying is the act of taking a previously configured and commissioned CSS to the field, momentarily disconnecting a slave modem from its associated RTU(s), interposing the CSS dongle between the slave modem and the RTU(s), and reconnecting them all so that the RTU(s) are connected transitively through the CSS dongle to the modem. CSMs are similarly deployed.

Configuring is the act of writing the non-volatile memory of a CSS with the current revision of the CSS software appropriate for the communications protocol of the network.

Security management component 110 operates to manage first security component 106 and second security component 108 by managing recovery keys and acting as an originating key server and code server. Security management component 110 has access to a random number generator, which is sometimes used to generate unpredictable encryption keys. In one embodiment, the security management component 110 is implemented as a key management center (KMC) in a computer that is physically secure, such as in a secured facility. A key management center (KMC) is a secured dedicated computer system connected to a network, such as the Internet, for license authentication, initial secret key administration, and key recovery by assisting a control system operator. A control system operator is a business enterprise responsible for operating a control system. The KMC is used to detect piracy and enforce licensing and to provide a service opportunity for a last-ditch remote dongle management reclamation service as well as to function as a key server and code server. The latter function is for code upgrades and to support new types of CSMs and CSSs. The dotted line connecting security management component 110 to security component 106 indicates that this communication is occasional rather than continuous.

A key is information (usually a sequence of random or pseudo-random binary digits) used initially to set up and periodically change the operations performed in cryptographic equipment or software for the purpose of encrypting or decrypting electronic signals. Key management is the process by which a key is generated, stored, protected, transferred, loaded, used, and destroyed. A secret key is the protected secret of secret key cryptography, used for both encryption and decryption. Secret key cryptography is a type of cryptography in which a shared secret is used for both encryption and decryption, in contrast with public key cryptography where different keys are used for encryption than for decryption.

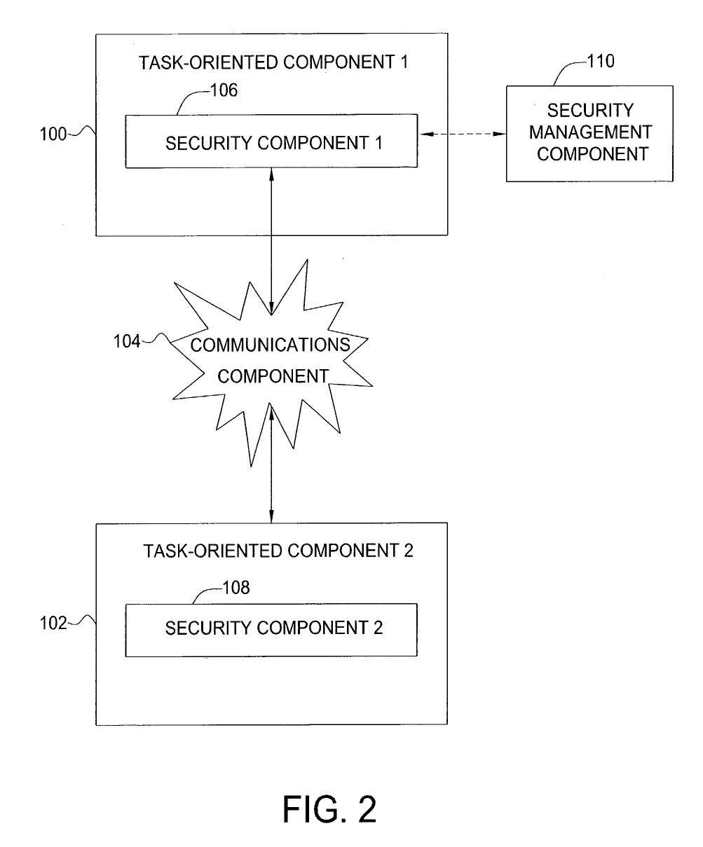

FIG. 2 shows another embodiment of a system for securing network communications. In comparing FIG. 1 and FIG. 2, in FIG. 2, the security components 106 and 108 are inside task-oriented components 100 and 102 instead of being interposed between task-oriented components 100 and 102 and communications component 104, as in FIG. 1. For example, if first security component 106 is implemented in software and first task-oriented component 100 is a computer, then first security component 106 comprises executable instructions, keys, and key-related data stored in memory on the computer.

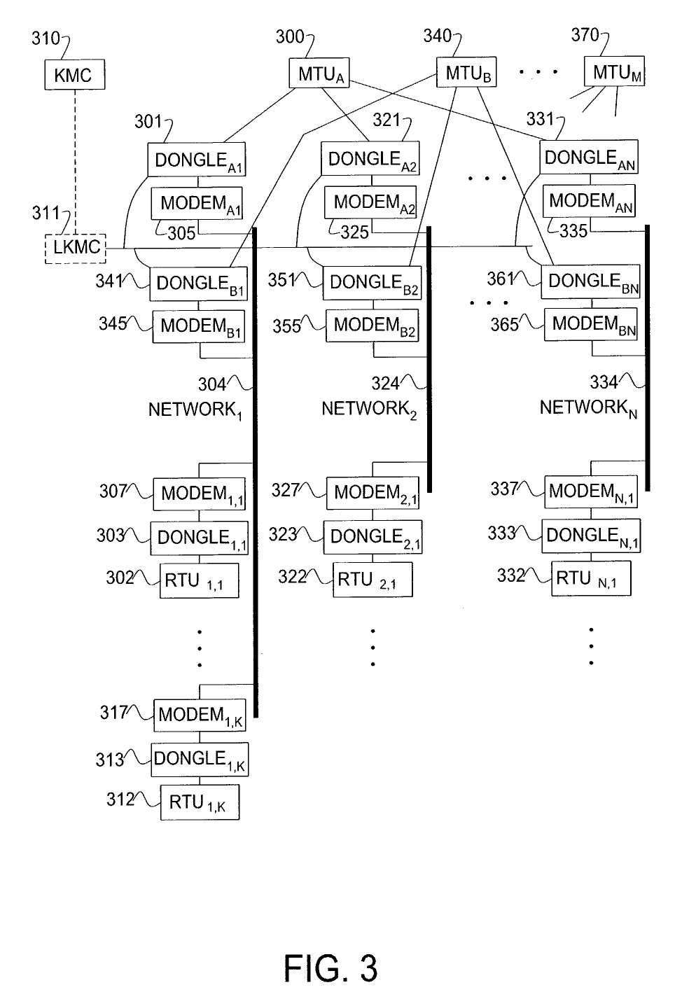

FIG. 3 shows a preferred embodiment of a system for securing network communications applied to a SCADA system. Like FIG. 1, FIG. 3 shows task-oriented components having secure communications over communications components. However, there are more task-oriented components and communications components in various configurations.

The general elements shown in FIG. 1 can be mapped onto the specific elements in FIG. 3. An example of first task-oriented component 100 of FIG. 1 is an MTU, such as MTU 300. An example of second task-oriented component 102 of FIG. 1 is an RTU, such as RTU 302. An example of communications component 104 of FIG. 1 is a plurality of networks and modems, such as network 304 and modems 305 and 307.

An example of security management component 110 of FIG. 1 is a KMC, such as a remote security management component KMC 310 coupled with a local security management component LKMC 311. The dotted line connecting KMC 310 to LKMC 311 indicates that this communication connection is occasional rather than continuous. The key server and code server functions are distributed so that, while they originate in the KMC 310, they are operationally either part of each CSM or part of a LKMC 311 surrogate and, thus, function continuously as an integral part of each CSM.

An example of first security component 106 of FIG. 1 is dongle 301 and an example of second security component 108 of FIG. 1 is dongle 303. Thus, in FIG. 3, MTU 300 and RTU 302 have secure communications over network 304 using modems 305 and 307 and the communication is secured by dongle 301, dongle 303, LKMC 311, and by KMC 310 as needed.

FIG. 3 also shows that a system for securing network communications scales up for multiple task-oriented components and security components. Of course, there are many different ways to arrange these components. In this example, multiple MTUs communicate with multiple RTUs over multiple networks. This communication is secured by multiple dongles in communication with LKMC 311.

Over network 304, MTU 300 has secure communications with RTU 302 through RTU 312. Over network 324, MTU 300 has secure communications with RTU 322 and other RTUs. Over network 334, MTU 300 has secure communications with RTU 332 and other RTUs.

MTU 300 has secure communications with RTU 302 over a communication path from MTU 300 to dongle 301 to modem 305 to network 304 to modem 307 to dongle 303 to RTU 302. Note that dongle 301 is interposed between MTU 300 and modem 305 and that dongle 303 is interposed between RTU 302 and modem 307. A communication path from MTU 300 to RTU 312 is from MTU 300 to dongle 301 to modem 305 to network 304 to modem 317 to dongle 313 to RTU 312.

MTU 300 has secure communications with RTU 322 over a communication path from MTU 300 to dongle 321 to modem 325 to network 324 to modem 327 to dongle 323 to RTU 322.

MTU 300 has secure communications with RTU 332 over a communication path from MTU 300 to dongle 331 to modem 335 to network 334 to modem 337 to dongle 333 to RTU 332.

Similarly, MTU 340 through MTU 370 have secure communications with various RTUs over various communication paths. MTU 340 has access to RTU 302 and RTU 312 through dongle 341 and modem 345. MTU 340 has access to RTU 322 through dongle 351 and modem 355. MTU 340 has access to RTU 332 through dongle 361 and modem 365.

While FIG. 3 shows an example configuration, many other configurations are possible. Some examples are:

1a. Many MTUs connect collectively to a single MTU dongle; or

1b. Many MTUs connect each to its own MTU dongle, which connect collectively to a single MTU modem; or

1c. Many MTUs connect each to its own MTU dongle and MTU modem, which latter connect collectively to a single network; and

2a. Many RTU modems with RTU dongles are connected to a common network representing one-to-many links; or

2b. Other networks have only a single RTU modem and RTU dongle, representing one-to-one links; and

3a. A single RTU connects to a single local RTU dongle; or

3b. Many RTUs connects to a single local RTU dongle.

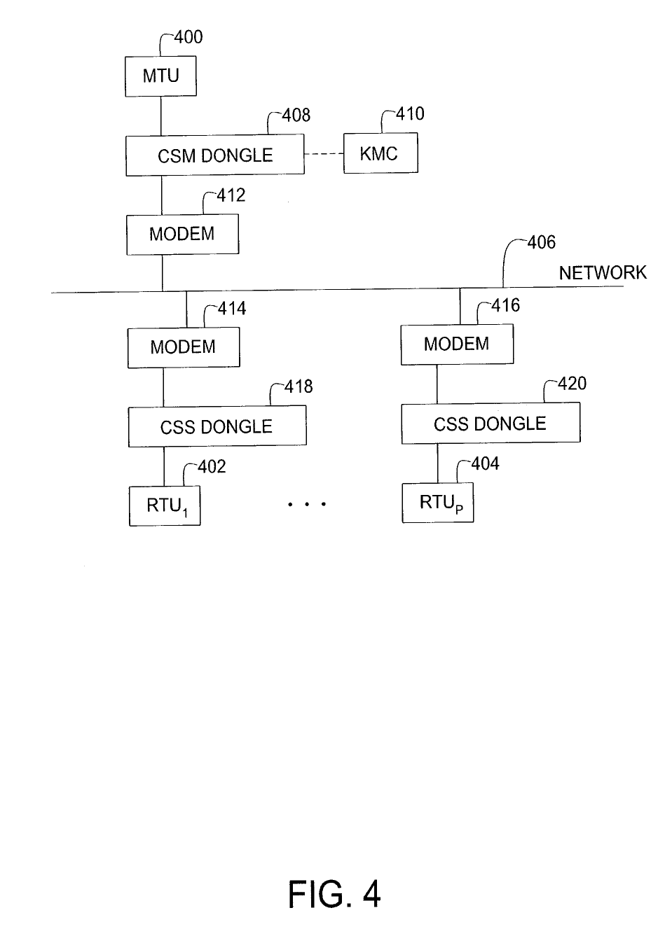

FIG. 4 shows another example of a system for securing network communications. An MTU 400 has secured communications with its RTUs, RTU 402 through RTU 404, via a network 406. FIG. 4 shows a specific implementation of dongles as CSM and CSS dongles. MTU 400 is in communication with CSM dongle 408, which is in communication with both KMC 410 and modem 412. Modem 412 is in communication with modems 414 and 416. Modem 414 is in communication with CSS dongle 418, which is in communication with RTU 402, while modem 416 is in communication with CSS dongle 420 that is in communication with RTU 404. A CSM dongle is a not quite so small device interposed between an MTU and its directly connected master modem(s), which acts as a CSM. A CSS dongle is a small device interposed between a slave modem and its directly-connected slave RTU(s) which acts as a CSS. FIG. 4 shows an example of master-slave networking, but peer-to-peer networking and other kinds of networking also work.

There is a means of adding communications security to existing and future control systems, such as power transmission and distribution systems, oil and gas pipelines, and regional or municipal water and sewage management systems. Some embodiments also provide a basis for adding compatible communications security to in-plant control networks, such as Foundation™ Fieldbus. Other embodiments also provide a basis for adding compatible communications security to internal local area networks (LANs) of process control systems, such as PlantScape® and Experion PKS™, which are available from Honeywell International Inc. in Morristown, N.J.

There is hardware and software for retrofit situations and for central control of communications security and software products for new equipment or where upgrade of existing product software is the chosen course.

Users include control system operators worldwide who have a need to secure their communications systems and defend them against cyberattack. The present invention is exportable to all the countries in the world, subject to any government-imposed restrictions.

Communications between a control site and its distributed RTUs are secured in a control system, such as a SCADA system. A control system that is an industrial measurement and control system comprises:

1. A central host or master (a/k/a MTU), which may be redundant;

2. One or more field data gathering and control units or remotes (a/k/a RTUs);

3. A multi-point communications channel (or a collection of point-to-point communications channels, or a combination thereof) from the MTU(s) to the RTUs and from each RTU to the MTU(s); and

4. A collection of standard and/or custom hardware and software used to monitor and control remotely located field equipment.

Most SCADA systems exhibit predominantly open-loop control characteristics and use predominantly long distance communications, although some elements of closed-loop control and/or short distance communications are also used. Other types of control systems have predominantly closed-loop control characteristics. Still other types use predominantly short- or medium-distance communications or both. There is a wide variety of mixtures of such features in control systems.

Communications security (ComSec) is retrofitted to existing SCADA wide area networks (WANs) or is included directly in new SCADA equipment and networks. Communications security (ComSec) is defined as measures and control taken to deny any unauthorized persons information derived from telecommunications and to ensure the authenticity of such telecommunications. Communications security includes cryptosecurity, transmission security, emission security, and physical security of ComSec material. Cryptosecurity is the component of communications security that results from the provision of technically sound cryptosystems and their proper use. When the existing equipment needs to remain unmodified, one approach is to place cyberprotective devices on the ends of the links at a point of exposed connection between the communicating end equipment and the intermediary modems that provide the network's physical signaling. For older equipment and systems, such exposed connection points usually exist, typically taking the form of RS-232 cables and connectors between equipment and nearby modems. Some example embodiments include the following:

1. A small connectorized package known as a dongle, the CSS dongle, at each field site of the network, which is interposed between a 9-pin RS-232/RS-423 serial port of a modem and its attached RTUs.

2. A somewhat larger dongle, the CSM dongle, at the central control site of the network that is interposed between a 9-pin RS-232/RS-423 serial port of an MTU and its attached modem(s).

3. A very small dongle, the power dongle, that can be plugged in series with the CSS dongle to power the CSS dongle when its available parasitically-derived power is insufficient.

4. The smaller dongle's software that is capable of being incorporated into an RTU by the RTU software vendor.

5. A PCI card form of the larger dongle, the CSM PCI card, that is interposed logically and perhaps physically in the information flow between the MTU and its attached modem(s).

6. Variants of (1), (2), and (5) above, supporting other types of serial ports, such as 8-pin and 25-pin RS-232/RS-423 connectors, 37-pin RS-422 connectors, and the like.

7. Variants of (2) above where the MTU connection is via USB, firewire, or a similar serial bus.

8. Variants of (3) above, supporting non-SCADA instrumentation, such as field instruments on an appropriate fieldbus.

9. Variants of (5) above without serial ports that provide ComSec and a dual high-speed Ethernet connection for time-critical process control LANs. For most utility, high-resolution time synchronization is also included.

The larger CSM dongle, (2) above, and some of the unplanned variants of the smaller CSS dongle are expected to need an external low-voltage power source. The CSS dongle, (1) above, is powered parasitically from its RS-232/RS-423 interfaces to a local modem and local equipment, such as an RTU.

The ComSec dongles and the power dongle target modems that are connected to an MTU or to one or more RTUs by an RS-232/RS-423 serial cable and connectors. The CSS software targets RTU vendors, whose RTUs include the following features:

1. Non-volatile rewritable program and data storage of at least 8 kB that are rewritable at least 20 times, e.g., flash memory.

2. Non-volatile rewritable data storage of at least (M+2)×64 B that can be rewritten at least 10,000 times, e.g., EEPROM, where M is the number of distinct multicast groups to which the device belongs.

The CSM PCI card targets MTU vendors whose equipment has an available PCI slot and which sometimes needs support for multiple concurrent RTU communications subnetworks.

For CSS and CSM dongles, there is no inherent restriction on the locale of manufacture of any hardware embodiment, because preferably no confidential or government restricted (for example, export controlled) software or hardware is present in either the embodiment or the manufacturing process at time of manufacture. There is a method for product preparation for distribution and sale. After manufacture and before placement into the distribution chain, a CSS or CSM dongle is sent to a trusted third party to preconfigure it with software and precommission it with unique identifying information and cryptographic secrets. A trusted third party installer is an agent that installs initial ComSec software and deviceunique information into newly-manufactured hardware devices before they are inserted into product distribution channels. This information is retained for escrow at a secure facility for use in assisting the system owner in failure recovery and for law enforcement use under a recognized court order. There are many reasons to use a trusted third party. First, it ensures that only the intended software is loaded into the device, so that the device may be manufactured in untrusted countries and facilities by uncleared personnel. Second, it supports revenue and customer service goals. Finally, it ensures compliance with government mandated requirements on the content of the software or the escrow of keys.

A trusted third party powers up one or more devices of a common type and downloads in parallel to their flash memories:

1. A boot loader that deciphers stream-enciphered download images given the appropriate key;

2. A download traffic encryption key (TEK); and

3. The current version of the software appropriate to the device, stream enciphered under that TEK.

It then downloads to each device separately:

1. A unique device class identifier (ID) and serial number;

2. A unique key for the device, known as the birth key encryption key (KEK); and

3. One or more encrypted versions of that birth KEK, where each encryption key is either a symmetric or public key common across all CSMs and CSSs.

Enciphering and deciphering involve ciphers. A cipher is a cryptographic system in which units of plaintext (unencrypted information) data are substituted according to a predetermined key, resulting in ciphertext (encrypted information) data. There are different kinds of ciphers, for example, block ciphers. A symmetric block cipher is a type of symmetric cipher that transforms a fixed-length block of plaintext into a block of ciphertext data. This transformation takes place under the action of a user-provided secret key. Applying the reverse transformation to the ciphertext block using the same secret key deciphers the block, resulting in the original plaintext. The fixed length is called the block size, which for modern block ciphers is typically 128 bits. Ciphertext is enciphered information. Plaintext is unencrypted information. Cleartext is synonymous with plaintext. To encipher is to convert plaintext into an unintelligible form by means of a cipher. A symmetric cipher is a reversible cipher which uses the same key to transform a plaintext data stream into a ciphertext data stream, or vice versa, depending on the direction of operation. A symmetric stream cipher is any symmetric cipher that changes how it behaves during a message. Such ciphers can be designed to be exceptionally fast, much faster than any block cipher. They usually work on small units of text, generating a keystream that is combined reversibly with the text to transform plaintext to ciphertext and vice versa, depending on the direction of operation.

In some embodiments, one public key is known to all CSMs, perhaps by preconfigured code, and another public key is known for use in key recovery assistance as ordered by competent legal authority. The preconfigured and precommissioned devices are then repackaged, after which they are ready for distribution and sale.

A public key is the unprotected key of public key cryptography, used for encryption or validating digital signatures or both. A private key is the protected key of public key cryptography, used for decryption or digital signing or both. Public key cryptography is the type of cryptography in which the encryption process is publicly available and unprotected, but in which a part of the decryption key (the private key) is protected so that only a party with knowledge of both parts of the decryption process can decrypt the ciphertext. Likewise for digital signatures, where the public key permits validating the signature but the private key is necessary to create the signature. A key encryption key (KEK) is a cipher key used to encrypt other keys. A traffic encryption key (TEK) is a symmetric cipher key used to encrypt plaintext and decrypt ciphertext or to super-encrypt and superdecrypt ciphertext, typically for a communications “session.”

There are installation and update methods. A control system operator has one or more CSM devices and an initial batch of CSS dongles or RTUs containing CSS software. Some control system operators have one CSM per MTU and one CSS per RTU modem, or per RTU where a modem is multidropped to many RTUs, plus an adequate number of spares of each.

There is a method for establishing a ComSec system. Each CSM is capable of establishing its own unique and intentionally non-interoperable ComSec system. This establishment occurs when an agent of the end user configures the CSM. Subsequent CSM and CSS devices are made members of the same ComSec system by any CSM that is currently a member of the system, which initially is just the first configured CSM.

There is a method for configuring and commissioning the initial CSM. The user agent that configures and commissions a CSM dongle applies power to the dongle and establishes a management dialogue with the dongle through the dongle's Ethernet port. In another embodiment, when these functions are separated into a local KMC surrogate (LKMC), then it is the LKMC that is powered and configured, rather than the attached dongle.

Through the management dialogue, the user agent specifies the communications protocol used by the control system. This specification is in the form of a selection among listed alternatives or in the form of a very small file, which describes the communications protocol to be secured, which is transferred to the CSM.

The user agent specifies the method by which the user's operational ComSec agents will authenticate commands to the ComSec system once it is operational, which occurs immediately after the CSM has been configured and commissioned. A common method would be the specification of two distinct pieces of information that are provided by two different individuals. This is known as two-person authentication. More complex authentication through weighted secret sharing is supported.

The user agent specifies the parameters of the key escrow provided by the system, such as the need for and duration of key escrow, the set of Internet or intranet network addresses to which escrowed keys should be sent, which may be a null set, and the desired immediacy or frequency of this transmission of escrowed keys to the specified address.

At this point, the CSM has been configured and commissioned and is prepared to form its own isolated ComSec system. The CSM generates the following items:

1. A unique system ID comprising its own device serial number concatenated with a count of the number of times it has created such a system ID.

2. A new key called the system KEK.

3. A unique system device ID, for example, an ID formed from the system ID concatenated with the count of the number CSMs which this CSM has commissioned, which is one (itself).

4. A second new key called a personal KEK. At this point, the CSM has established its own isolated ComSec system.

There are various methods of operation. One method of operation is for adding ComSec to the control system communications. One method of operation for adding ComSec to the control system communications is a method for discovery of unicast RTU addresses. While operating almost transparently, the CSM analyzes the message headers of the messages it forwards, isolating the unicast addresses and multicast addresses in use on the network. It retains these addresses to manage its CSSs.

Periodically during its operation, the CSM delays giving its attached MTU a clear-to-send signal, forcing the MTU to wait while the CSM communicates with some RTU's CSS on its own. The length of this delay is short, perhaps 50 ms on a 2400 bit/s communications network, and proportionately less at higher data rates. During this interval, the CSM sends a ComSec poll message to one of the RTU unicast addresses that the CSM has observed and saved and which is not known to have an associated CSS. The form of the ComSec poll is protocol specific, but it is always a message that will be ignored or treated as an error by an RTU that does not have an interposed CSS.

If there is a newly-installed CSS at the polled address, the CSS responds to the CSM with a secure ComSec reply message, giving the CSS's system ID and the list of unicast addresses to which the CSS's RTUs have responded, all authenticated with the KEK the CSM (or one of its peer CSMs in the same ComSec system) wrote into the CSS during its commissioning. The CSM associates the CSS's ID with the polled address and with any other addresses that the CSS has given in its response. The CSM stops further polling of those addresses unless the CSS and its RTUs should become non-responsive.

There is a method for establishing ComSec for discovered addresses. At a time of its choosing, the CSM sends the CSS a new session key, stream enciphered under the CSS's KEK, and associates that key with the unicast RTU address(es) of the CSS. A session key is a TEK for the set of messages that comprise a communications session. From that point on, all communications with the CSS and its RTU(s) are stream-enciphered and secured, unless the CSS becomes non-responsive or is replaced by another dongle, in which case the low-frequency poll of the affected address is restarted.

If there are multiple CSMs for redundant MTUs, the CSM shares: the CSS system ID, the newly-created session key, and the set of addresses associated with that session key with its peer CSMs via their shared inter-CSM connection, which may be an Ethernet connection. This sharing has sequence numbers; so after powerup, each CSM can inquire of the others whether any update messages have been lost and, if so, request a replacement copy of either the lost information or the full database.

These tables of CSS system IDs, keys, and set of associated addresses are retained in memory, such as the internal RAM of the CSM. If an implementation has CSM hardware with the EEPROM external to the micro-controller chip, then they are also written, with at least the key in enciphered form, to a memory, such as key storage EEPROM within the CSM, under a key created by the CSM for that purpose, after copying any prior key information for that CSS from the EEPROM to a large key escrow flash memory within the CSM. If the EEPROM is external to the microcontroller chip, then the information in the EEPROM is enciphered under a key retained within the microcontroller chip. EEPROM is non-volatile memory which has been specially constructed to be erasable and capable of being rewritten a large number of times, typically 10⁶ times. Flash memory is non-volatile memory, of higher density and lower cost per bit than EEPROM, which has been specially constructed to be erasable and capable of being rewritten a limited number of times, typically 50-10,000 times. Thus, in one embodiment, operational key information is stored within the CSM's RAM, while an enciphered form is retained in the non-volatile key storage EEPROM and prior keys are retained in enciphered form in the non-volatile key escrow flash memory when key escrow is configured.

Another method of operation is a method for establishing ComSec for some multicast addresses before full system ComSec has been established. Multicast addresses other than the broadcast address are discovered in messages from the MTU, but the set of RTUs that is addressed by such a multicast address is usually not discoverable. Unlike the recipients of unicast messages, multicast message recipients do not generate an immediate reply message from which their identity can be learned. Thus, the CSM assumes the entire set of CSSs are potential intended recipients of each multicast address, except when explicit information on set membership is provided through an extension of CSM configuration.

For each distinct multicast set, as soon as all of the RTU addresses in that set are known to have interposed CSSs, and those CSSs have been given the key(s) for the multicast address(es) associated with that set, then the CSM notifies the involved CSSs that it will now apply ComSec protection to messages addressed to multicast addresses of that set. Thus, the CSM provides ComSec protection for all network addresses, including any multicast address(es), as soon as all of the RTUs in the network have interposed CSSs and the appropriate session keys are shared.

If incremental protection of multicast groups is desired before CSSs have been interposed at all RTUs, then the CSM needs outside assistance before it can secure those groups while leaving other groups unsecured. Because the CSM cannot infer the membership of these multicast groups on its own, it learns the information from the control system operator.

During normal operation, even while operating completely transparently, the CSM observes the multicast addresses in messages that it is sending. It accumulates this list and provides it on request to the control system operator via a network, such as an Ethernet connection.

Whether in a delayed response or on his/her own, an agent of the system operator sends a list of the set of RTU unicast addresses that are members of each multicast set to the CSM. Upon receipt of the list, the CSM analyses the multicast group membership as previously described, creates new keys as appropriate, and sends messages to each of the affected CSSs, giving them the appropriate subset of the new keys and the multicast group address(es) associated with each of those keys.

Another method of operation is a method for ComSec overlay of control system communications. This method includes how ComSec is applied to and modifies the RTU messaging. With respect to the pre-ComSec communications, the CSM and CSSs have the following goals: (1) add ComSec to some or all of the messaging on the control network to be secured, typically a WAN, (2) minimize the delay they induce in the control system communications cycle, and (3) minimize the impact of this addition on the RTUs and the MTU(s).

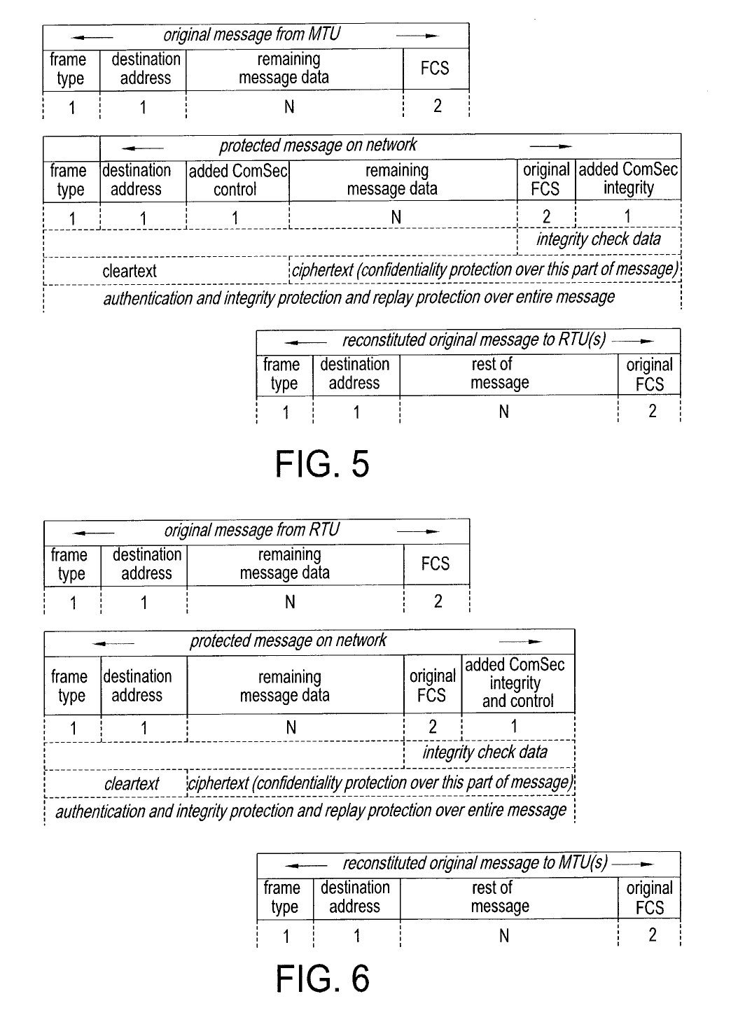

FIG. 5 shows a typical SCADA message structure and transformation for MTU to RTU messages and for RTU to MTU messages that are not constrained to be reply messages. FIG. 6 shows a typical SCADA message structure and transformation for RTU to MTU reply messages when all RTU to MTU messages are necessarily reply messages.

The CSM analyzes each message as it is received from the attached MTU and determines the destination address for the message. If the message is addressed to a single RTU protected by an active CSS or to a multicast group that is known to be a group entirely of RTUs protected by active CSSs, then the CSM alters the message (see FIG. 5) to provide source authentication, confidentiality, integrity protection and replay protection, before transmitting the altered message to the attached modem(s). Otherwise, the message is passed through to the modem(s) transparently. A CSS performs a similar alteration of RTU to MTU communications (see FIGS. 5 and 6) to provide ComSec on the RTU's transmissions.

The message alteration includes adding ComSec control and integrity information, with the consequence that RTUs not yet secured by their own CSS will be exposed to this lengthened messaging. This lengthening never occurs on messaging intended for the unsecured RTUs; it only occurs on messaging for ComSec-secured RTUs that the ComSec-unsecured RTUs are overhearing. For some RTU software, these lengthened messages will go unnoticed; but for other RTUs it is possible that the changes in the messaging gives rise to checksum or FCS-check errors, and the extra message characters can cause receive buffer overflow errors. A checksum or frame check sequence (FCS) is redundancy bits based on polynomial algebra added to a message to support receiver detection of errors that occurred subsequent to transmission. These potential problems disappear when each RTU has its communications protected by a CSS.

These potential problems are eliminated by installing CSSs at all RTUs before applying ComSec protection to the system. In that scenario each CSS passes messages transparently during the period when the CSSs are being installed. When installation is complete, the CSM discovers that all of the RTUs have an intervening CSS. At that point, the CSM commands all of the CSSs, usually by repeated broadcast messages, to transition the network to a ComSec protected state. After the transition, the CSM and CSSs are able to suppress all evidence of their protection from the attached RTUs and MTU(s) other than the increased communications delay.

The performance impact of adding ComSec to the RTU messaging depends on the RTU protocol. Typically, messages to RTUs are extended by one or two characters and reply messages from RTUs are extended by zero or one character. Each connectorized module adds delay, typically one character in each direction; RTU and MTU embedded software and MTU PCI card modules do not.

The message checksum or FCS appended by the MTU is carried through to the RTUs, providing end-to-end detection of message corruption, both between transmitter and receiver and within the ComSec hardware and software. Similarly, the message checksum or FCS appended by the RTU is carried through to the MTU(s), providing end-to-end detection of message corruption, both between transmitter and receiver and within the ComSec hardware and software. In the unlikely event that the network has intermediary nodes such as bridges or routers that discard messages without a valid checksum or FCS, the CSM and CSS append an extra, newly-computed valid checksum or FCS to each enciphered message and discard that added checksum or FCS on receipt.

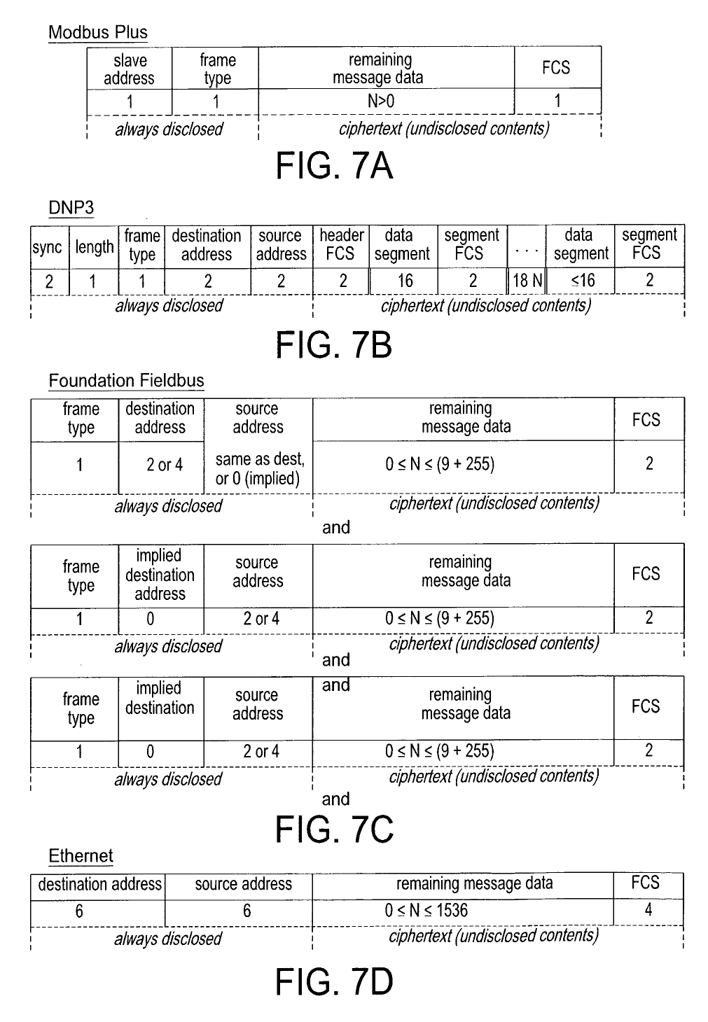

FIGS. 7A, 7B, 7C, and 7D show layouts of message structures of various types of messaging protocols frequently used in SCADA and non-SCADA control systems. These figures identify the portion of each message that is protected against eavesdroppers and show the example protocols Modbus plus, DNP3, FOUNDATION™ Fieldbus, and Ethernet. FIGS. 7A and 7B show SCADA message structures of Modbus plus and DNP3. FIGS. 7C and 7D show the message structure of other protocols commonly used in control systems. All four figures identify the portion of each message that is concealed from eavesdroppers.

The general method for transforming a message on the protected portion of the link, i.e., that between CSM(s) and CSSs, comprises:

1. If the protocol requires inspection of message contents to determine the intended recipient(s) of the message, e.g., on a message from MTU to RTU, or on all but some immediate acknowledgement messages in peer-to-peer systems and in some SCADA systems, then the information required to determine the endpoint correspondents of the communication and whether or not the message has an associated immediate reply, together with any prior message portion, is transmitted as cleartext. All other information is encrypted and transmitted as ciphertext.

2. When the message is not an immediate reply intended only for the sender of the immediately prior message, one character of ComSec control information is inserted as cleartext just after the information that determines those intended recipients or, if there is no such information, at the beginning of the message.

3. If the total amount of checksum or FCS information at the end of the message is less than, say, 20 bits, one or more characters of ComSec integrity information is suffixed to the message before encryption. When such information is appended, one or two bits of ComSec control information also may be included within these suffixed character(s).

4. If neither of the prior two steps resulted in message expansion, one character of ComSec control information is suffixed to the message before encryption.

5. If the transmission system discards messages in transit when it determines that those messages have an invalid checksum or FCS, a second cleartext checksum or FCS computed over the modified message is suffixed to the message after encryption.

Another method of operation is a method for MTU transmission through a CSM. When an MTU starts to transmit to its modem through an active CSM, the CSM inspects the initial characters of the message as soon as they are available and determines the message type, message source and set of intended message recipients. If the message is for a communications relationship to which ComSec is not being applied, the CSM forwards the message to the MTU's modem(s) without any modification. If the message is for a communications relationship for which ComSec is active, the CSM retrieves the current session key associated with this source and destination set and increments the message sequence number associated with that session key. It computes an initialization vector (IV) from the session key and new message sequence number. In one embodiment, after initializing the stream cipher with the session key and IV, the CSM sequentially inputs the previously received message characters to the stream cipher to include them in the message integrity check.

When the CSM gets to the protocol determined point in the message where confidentiality is to begin, which is typically immediately after the address(es) that determine(s) the correspondents, the CSM inserts a ComSec control character into the input stream before the next character received from the MTU. That ComSec control character conveys part of the key-associated ComSec sequence number of the current message to the receiving CSSs, helping them to synchronize after lost messages or brief outages. It also includes one or more Isbs of the count of keying epochs, used to cause switchover to new session keys sets after rekeying and to assist in detecting loss of synchronization of session key sets. Least significant bits (Isbs) are the low-order bits of a multi-bit integer such as that represented in a character, byte, or word. The ComSec control character is forwarded to the CSSs as cleartext; confidentiality begins with the next received character.

After forwarding the ComSec control character, additional characters are forwarded to the CSSs after being transformed by the stream cipher. Thus, their original value is retrievable only by those receiving CSSs that share the session key and infer the same IV; those CSSs perform the inverse stream decipherment of the received characters. When the CSM receives the end of the message transmitted by the MTU, it passes a fixed number of additional bytes (usually one, possibly zero) of predictable integrity data through the stream cipher and sends the stream cipher's output to the attached modem(s). The use of the original checksum or FCS as part of the integrity check data reduces the number of extra characters that are added to the communications stream and maintains end-to-end message error detection.

Any RTU that does not have an intervening CSS will be exposed to messaging as altered by the CSM. Although the message is not addressed to such an RTU, the RTU's low-level functions may process the entire message. In that case the RTU receives a message of altered length and content that has a detectable checksum or FCS error with probability 1-2^{-N}, where N is the bit length of the checksum or FCS field. The RTU's low-level error counters may increment upon detecting the error but; since the message is not addressed to the RTU, the message is unlikely to have more deleterious side effects, even if it is further corrupted during transmission. In the unlikely event that the network has intermediary nodes such as bridges or routers that discard messages without a valid checksum or FCS, the CSM computes and appends such a checksum or FCS for the enciphered message.

Another method of operation is a method for retrieval of escrowed keys from an operational CSM. Retrieval of escrowed keys from an operational CSM includes authenticating the requests, specifying selection criteria and processing.

Weighted secret-sharing is used to authenticate the retrieval. A session key is shared during the authentication process. Once authenticated, the CSM accepts any key escrow retrieval request for say the next 24 hours.

As a last-ditch backup for the control system operator or law enforcement, the KMC creates a system-specific four-part secret, usable only once, where one part of the secret is entered into the CSM via each of the CSM's four ports—the Ethernet, modem, MTU, and dongle commissioning ports. After being presented with such a multipart key, combining the parts and authenticating the secret with the CSM's system KEK, the CSM accepts any key escrow retrieval request for, say, the next 24 hours.

The resulting key escrow information is itself enciphered under a session key conveyed as part of the KMC-originated four-part secret, to protect the escrowed information during transmission. That session key is obtained from the KMC at the same time as the secret.

All KEKs and backup KEKs, and the current set of session keys, are stored in and retrievable from the EEPROM. All prior KEKs and session keys are escrowed in the flash memory. The selection of keys to be retrieved is specified by a combination of date range and session range. Data range includes a range of calendar dates of interest or a range of days of interest relative to the current day, or all dates. Session range includes a set of RTU addresses, or a set of RTU addresses that designate RTUs that indirectly designate the set of all unicast and multicast addresses for which the CSSs forwarded messages to those RTUs, or all sessions. Conceptually, the retrieved keys are organized as a series of records of the following types:

1. Address record having a sequence of RTU addresses documenting the known RTU addresses for the control system, with the unicast addresses listed first;

2. Full key record having an initial entry giving starting time and duration for the applicability of the following keys, the type of keys listed, such as KEK, backup KEK, and session, a series of session keys, one for each RTU address in the nearest preceding address record (see 1 above); and

3. Partial key record having an initial entry giving the starting time and duration for the applicability of the following session keys and a series of triplets of

type of the keys listed, such as KEK, backup KEK, and session,

RTU address, and

corresponding key.

All of these records are enciphered under a session key before transmission over the Ethernet or Internet. When backup authentication by the KMC is invoked, the session key is provided by the KMC as part of the authorizing four-part secret.

The present disclosure may be implemented according to some performance considerations for the CSS dongle, the CSM dongle, CSS software, and CSM PCI card, but is not intended to be limited by these example performance considerations in any way.

A CSS dongle has an EEPROM or equivalent able to store two master keys plus two sets of session keys for each distinct unicast or multicast group of addresses for which it offers ComSec protection. It also has enough additional EEPROM or equivalent to store the protocol address associated with each group. A small amount of additional EEPROM or equivalent is also needed. The initial version of the CSS dongle is able to store the session keys associated with one unicast and three multicast groups. Other versions of the dongle with larger EEPROMs or equivalent (with the same circuit design) are made, if this is too few keys for the target markets.

The CSS dongle is able to handle common communication speeds up to 115.2 kbit/s operating in a non-overlapping two-way-alternate mode (between RTU and modem). It is desirable that the dongle handle overlapped two-way alternate and full-duplex two-way-simultaneous communication. If the impact on power of the higher frequency crystal is not too onerous, it is desirable that the dongle handle the higher data rate of 230.4 kbit/s.

A CSM dongle has an EEPROM or equivalent able to store four master keys plus two sets of session keys for each unicast or multicast group for which it offers ComSec protection. It also has enough additional EEPROM or equivalent to store the protocol addresses associated with each group. A small amount of additional EEPROM or equivalent is also needed.

The initial CSM dongle is able to store the session keys associated with 500 unicast and multicast groups. Other versions of the CSM dongle with smaller EEPROMs or equivalent (with the same pad footprint) are made, if this is too many keys.

The CSM dongle is able to handle common communication speeds up to 230.4 kbit/s operating in an overlapping two-way alternate or a full-duplex two-way simultaneous mode (between MTU and modem).

An embedded instance of CSS software has a dedicated EEPROM or equivalent storage able to store two master keys plus two sets of session keys for each unicast or multicast group for which it offers ComSec protection. It also has enough additional dedicated EEPROM or equivalent storage to store protocol addresses associated with each group. A small amount of additional EEPROM or equivalent storage is also desired.

The CSM PCI card provides full-duplex ComSec messaging services at its PCI interface, as well as on its external RS-232/RS-423 serial ports. Each message presented at the card's API interface is presented in parallel as a record. It is transformed as a unit between plaintext and ciphertext without the delays caused by serial processing of a message received as the serial communications port.

Implementations are initialized at the point of manufacture with a minimal cleartext downloader. All subsequent code, including all cryptographic software, is installed later, often in the country of use. This choice supports country specific constraints based on the country of manufacture and the country of use. It improves the likelihood that the downloaded software is the current version, including fixes for any recently uncovered security flaws.

Secrets are shared between the CSM and CSS. The need to have a secret key that is shared only by a CSS and its CSM(s), and the desire to avoid needing public key encryption in a CSS dongle, drives the basic CSS dongle commissioning strategy. This results in a policy of directly connecting an uncommissioned CSS dongle to a CSM so that the CSM can create and download a key unique to their association. CSS dongles can be commissioned en masse, anytime after they arrive at the site of one of their eventual CSMs and before they are taken or shipped to the field for deployment. CSMs are interconnected as a redundant set of equals, any one of which can commission a CSS dongle. Since the CSMs communicate with each other over secured connections through their Ethernet ports, it is possible for one member of the redundant set to be a maintenance or service site distant from the control systems operations center, connected either by private means or by the Internet.

The desire to authenticate a CSM and system license and to provide shared secrets with the KMC drives the basic CSM commissioning method, which needs the CSM to have direct but potentially intermittent communication with the KMC. The burden of this communication is lessened by the ability to configure the CSM before it is brought to the control system site.

CSS instances are initialized. The vendor of RTU software enters a unique bytestring in each CSS software instance. The desire to authenticate each CSS instance drives the need for the CSM to have direct or indirect communication with the KMC. This communication is non-real time. Information from multiple unauthenticated CSSs is aggregated into a single request to the KMC and a single response. The control system is sometimes air gapped or isolated in time and space from the system that communicates with the KMC.

It is to be understood that the above description is intended to be illustrative and not restrictive. Many other embodiments will be apparent to those of skill in the art upon reviewing the above description, such as adaptations of the present invention to various hardware, software, and firmware forms. Various types of networks, such as local area networks are contemplated by the present invention, even though some minor elements would need to change to better support the low-delay peer-to-peer environment common to such networks. The present invention has applicability to fields outside SCADA networks, such as field instrument networks, communications networks of distributed control system (DCS), enterprise building integrator (EBI) systems, and other time-critical systems. Therefore, the scope of the present invention should be determined with reference to the appended claims, along with the full scope of equivalents to which such claims are entitled.

What is claimed is:

1. A system for securing network communications, comprising:
a first security component;
a second security component; and
a security management component;
wherein said first security component, said second security component, and said security management component are capable of providing security for a communication between a first task-oriented component and a second task-oriented component.

2. The system according to claim 1, wherein said provided security relates to at least one security attribute selected from the group consisting of: source authentication, confidentiality, integrity protection, and replay protection.

3. The system according to claim 1, further comprising:
a communications component in communication with said first security component and said second security component;
wherein said first security component is in communication with said first task-oriented component and said security management component; and
wherein said second task-oriented component is in communication with said second security component.

4. The system according to claim 3, wherein said first security component is a first dongle.

5. The system according to claim 3, wherein said first security component comprises executable instructions capable of being stored in said first task-oriented component.

6. The system according to claim 3, wherein said second security component is a second dongle.

7. The system according to claim 3, wherein said second security component comprises executable instructions capable of being stored in said second task-oriented component.

8. The system according to claim 3, wherein said first task-oriented component is a first master terminal unit (MTU) and said second task-oriented component is a first remote terminal unit (RTU) in a control system.

9. The system according to claim 8, further comprising:
a third security component in communication with said communications component; and
a second remote terminal unit (RTU) in communication with said third security component.

10. The system according to claim 9, wherein said first security component, said third security component, and said security management component are capable of providing source authentication, confidentiality, integrity protection, or replay protection for a communication between said first master terminal unit (MTU) and said second remote terminal unit (RTU).

11. The system according to claim 8, further comprising:
a second master terminal unit (MTU) in communication with said security management component; and
a third security component in communication with said second master terminal unit (MTU).

12. The system according to claim 11, wherein said first security component, said third security component, and said security management component are capable of providing source authentication, confidentiality, integrity protection, or replay protection for a communication between said second master terminal unit (MTU) and said first remote terminal unit (RTU).

13. The system according to claim 3, wherein said control system is applied to an application, said system being selected from the group consisting of: power transmission and distribution, oil and gas pipeline, and water and sewage management.

14. The system according to claim 8, wherein said first master terminal unit (MTU) is part of a control site.

15. The system according to claim 8, wherein said communications component is a wide area network (WAN).

16. The system according to claim 3, wherein said security management component serves executable instructions to said first security component.

17. The system according to claim 3, wherein said security management component serves keys to said first security component and has access to a random number source.

18. The system according to claim 3, wherein said second task-oriented component is a field instrument.

19. The system according to claim 3, wherein said second task-oriented component is located remotely from said first task-oriented component.

20. A method for securing network communications, comprising:
commissioning, by a security management component, a first security component;
commissioning, by said security management component, a second security component; and
altering, by said first security component and said second security component, a communication between a first task-oriented component and a second task-oriented component;
wherein said first security component, said second security component, and said security management component are capable of providing security for said communication between said first task-oriented component and said second task-oriented component.

21. The method according to claim 20, further comprising:
precommissioning said first security component with a unique identifier and at least one cryptographic secret.

22. The method according to claim 21, further comprising:
storing said unique identifier and said at least one cryptographic secret.

23. The method according to claim 20, further comprising:
deploying said first security component to be in communication with said first task-oriented component and a communications component; and
deploying said second security component to be in communication with said communications component and said second task-oriented component.

24. The method according to claim 20, wherein said providing security for said communication is at least one selected from the group consisting of:
source authentication, confidentiality, integrity protection, and replay protection.

25. The method according to claim 21, wherein said precommissioning comprises:
obtaining a session key to said first security component;
obtaining executable instructions enciphered under said session key to said first security component;
obtaining a birth key encryption key (KEK) to said first security component; and
obtaining at least one encrypted version of said birth key encryption key (KEK) to said first security component.

26. The method according to claim 25, further comprising:
obtaining a boot loader to said first security component; and
obtaining a class identifier and an identifier to said first security component.

27. The method according to claim 21, wherein said first security component is a dongle having an indicator for indicating that said precommissioning has completed.

28. The method according to claim 20, wherein said commissioning comprises:
activating a bootstrap program on said first security component to erase a flash memory of said first security component;
providing executable instructions to said first security component to load into said flash memory;
authenticating said first security component; and
validating said first security component.

29. The method according to claim 28, further comprising:
interrogating said first security component to determine that said first security component needs commissioning.

30. The method according to claim 20, wherein said altering comprises:
adding, by said first security component, control and integrity information and encrypting a resulting expanded message; and
decrypting, by said second security component, said resulting expanded message and removing said control and integrity information.

31. The method according to claim 20, wherein said first task-oriented component is a master terminal unit (MTU) and said second task-oriented component is a remote terminal unit (RTU) in a control system.

32. The method according to claim 20, wherein said communications component is a wide area network (WAN).

33. The method according to claim 20, wherein said first security component is a dongle interposed between said first task-oriented component and a modem.

34. A computer-readable medium having computer-executable instructions for performing a method, comprising:
commissioning, by a security management component, a first security component;
commissioning, by said security management component, a second security component; and
altering, by said first security component and said second security component, a communication between a first task-oriented component and a second task-oriented component;
wherein said first security component, said second security component, and said security management component are capable of providing security for said communication between said first task-oriented component and said second task-oriented component.
